(19) United States
(12) Patent Application Publication
(10) Pub. No.: US 2025/0379314 A1
(43) Pub. Date: Dec. 11, 2025

(54) STRUCTURE AND METHOD FOR FIXING BATTERY MODULE TO BATTERY PACK

(71) Applicant: Isuzu Motors Limited, Yokohama-shi (JP)

(72) Inventor: Hiroyuki SUGAWARA, Fujisawa-shi (JP)

(73) Assignee: Isuzu Motors Limited, Yokohama-shi (JP)

(21) Appl. No.: 19/232,954

(22) Filed: Jun. 10, 2025

(30) Foreign Application Priority Data
Jun. 11, 2024 (JP) 2024-094370

(51) Int. Cl. H01M 50/244; H01M 50/213; H01M 50/264

(52) U.S. Cl. CPC H01M 50/244; H01M 50/213; H01M 50/264

(57) ABSTRACT

A fixing structure capable of fixing a battery module to a battery pack in a more preferred mode is provided. Main body housing 10 of battery module 1 according to the present disclosure includes a plurality of cell housing holes 10a each for housing battery cell 11. In at least one of the plurality of cell housing holes 10a, battery cell 11 is not disposed and screw receiving member 12 is disposed in place of battery cell 11. Screw member Ba is disposed so as to be inserted through a through hole 10b formed in the side wall of main body housing 10 via bracket Pb fixed to battery pack P, and main body housing 10 is fixed to battery pack P by fastening with screw hole 12a of screw receiving member 12.

### RELATED APPLICATION(S)

This application claims the benefit of priority of Japan Patent Application No. 2024-094370, filed on Jun. 11, 2024, the contents of which are incorporated by reference as if fully set forth herein in their entirety.

### TECHNICAL FIELD

The present disclosure relates to a structure and method for fixing a battery module to a battery pack.

### BACKGROUND ART

Secondary batteries are used not only in portable devices but also in a variety of devices that are driven by an electrical drive source, such as electric vehicles and hybrid vehicles. In particular, lithium ion batteries are attracting attention as a new energy source because of their high performance, such as high energy density, small size, and light weight.

Battery cells of such secondary batteries typically have a 3V operating voltage. Therefore, when an output voltage higher than such a typical voltage is required, a plurality of battery cells are connected in series and used as a battery pack. In addition, according to the required charge/discharge capacity, a plurality of battery cells may be connected in parallel and used as a battery pack. In such a manner, the number of battery cells included in a battery pack is variously set according to the required output voltage and charge/discharge capacity.

### CITATION LIST

### Patent Literature

### PTL 1

Japanese Unexamined Patent Application Publication (Translation of PCT Application) No. 2020-514978

### SUMMARY OF INVENTION

### Technical Problem

A battery pack of the above type is generally configured by connecting a plurality of battery modules, each of which stores a large number of battery cells (see, for example, PTL 1). Each of the battery modules is usually configured with a fastening structure on the outer side surface of the main body housing of the battery module, and is configured to be fixed to a battery pack or other battery modules by the fastening structure.

However, according to such a configuration, the size of the main body housing of the battery module is increased by the amount required to provide the fastening structure on the outer side surface. In other words, this means that the size of the battery pack as a whole increases. This means that the energy density is lowered, which is a major problem in electric vehicles and other applications where maximizing energy density in a limited space is an urgent issue.

In addition, according to such a configuration, it is necessary to design a fastening structure specifically for each battery pack variation, which causes a problem of increased mold costs for manufacturing the battery module. In particular, in a vehicle, the fixing position of a battery module to a battery pack and the number of fixing screws are designed in consideration of the vibration mode (i.e., vibration direction and vibration acceleration) that is assumed in the vehicle and interference with other mounted equipment. Furthermore, the mode in which the battery modules are fixed to the battery pack will differ depending on the number of battery modules mounted in the battery pack and the layout of the battery modules within the battery pack. In such cases, when the fastening structure of the battery module were to be specially designed according to the type of battery pack, the number of types of battery modules would increase, leading to higher product manufacturing costs.

The present disclosure has been made in view of the above-described problems, and an object thereof is to provide a fixing structure capable of fixing a battery module to a battery pack in a more preferable mode, and a method for fixing the battery module (herein also referred to as “fixing method).

### Solution to Problem

The main present disclosure which solves the aforementioned problems is the following fixing structure. A structure for fixing a battery module to a battery pack, in which:
a main body housing of the battery module includes a plurality of cell housing holes each for housing a battery cell;
in at least one cell housing hole of the plurality of cell housing holes, the battery cell is not disposed, and a screw receiving member is disposed in place of the battery cell; and
a screw member is disposed so as to pass through a through hole via a bracket fixed to the battery pack, and the main body housing is fixed to the battery pack by fastening the screw member to a screw hole of the screw receiving member, the through hole being formed in a side wall of the main body housing.

In another aspect, a fixing method is provided as follows. A method for fixing a battery module to a battery pack, the method including:
preparing a main body housing of the battery module, the main body housing including a plurality of cell housing holes each for housing a battery cell;
placing the battery module in the battery pack with the battery cell not disposed and a screw receiving member disposed in place of the battery cell in at least one cell housing hole among the plurality of cell housing holes; and
disposing a screw member so as to pass through a through hole via a bracket that is for fixing to the battery pack, and fastening the screw member to a screw hole of the screw receiving member, the through hole being formed in a side wall of the main body housing.

### Advantageous Effects of Invention

The structure for fixing a battery module to a battery pack according to the present invention is more preferable in terms of reduction of the size of a battery module and a variation design of the battery pack.

### BRIEF DESCRIPTION OF DRAWINGS

FIG. 1 illustrates a state in which a battery module is stored in a battery pack according to an embodiment of the present invention;

FIG. 2 is a plan view illustrating a state in which battery cells are stored in cell housing holes of the battery module according to the embodiment of the present invention;

FIG. 3 illustrates a state in which the battery cells are stored in the cell housing holes of the battery module according to the embodiment of the present invention as viewed obliquely from above;

FIG. 4 is a plan view illustrating a configuration of the cell housing holes and through holes formed in a main body housing of the battery module according to the embodiment of the present invention;

FIG. 5 illustrates the configuration of a variation of the structure for fixing the battery module to the battery pack; and

FIG. 6 illustrates the configuration of the screw receiving member according to the variation.

### DESCRIPTION OF EMBODIMENTS

A preferred embodiment of the present disclosure will be described in detail with reference to the attached drawings. In the present specification and the drawings, components having substantially the same functions are denoted by the same reference numerals and redundant explanations will be omitted.

In order to clarify the positional relationship in the configurations, each drawing shows a common orthogonal coordinate system (X, Y, Z). The positive direction in the Z axis represents the upward direction of a battery pack, and the X and Y axes represent the lateral directions of the battery pack orthogonal to the Z axis. However, these directions do not limit the posture of the battery pack of the present invention during use.

Hereinafter, a configuration of a battery pack (hereinafter, referred to as “battery pack P”) according to an embodiment of the present invention and an example of a structure for fixing a battery module (hereinafter, referred to as “battery module 1”) to this battery pack P will be described. Battery pack P according to the present embodiment is, for example, mounted on an electrically-driven vehicle such as an electric vehicle or a hybrid vehicle, and is used as a driving power source for the vehicle.

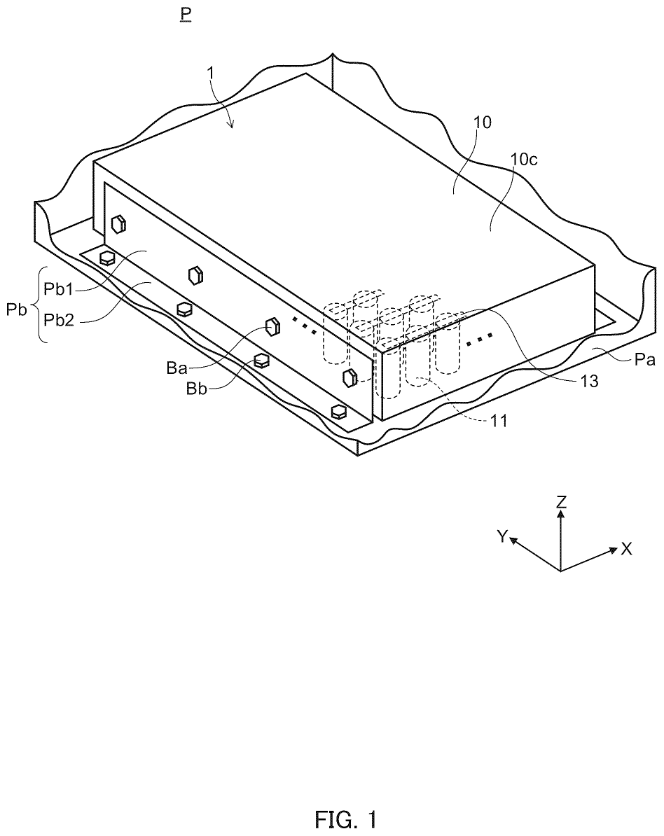

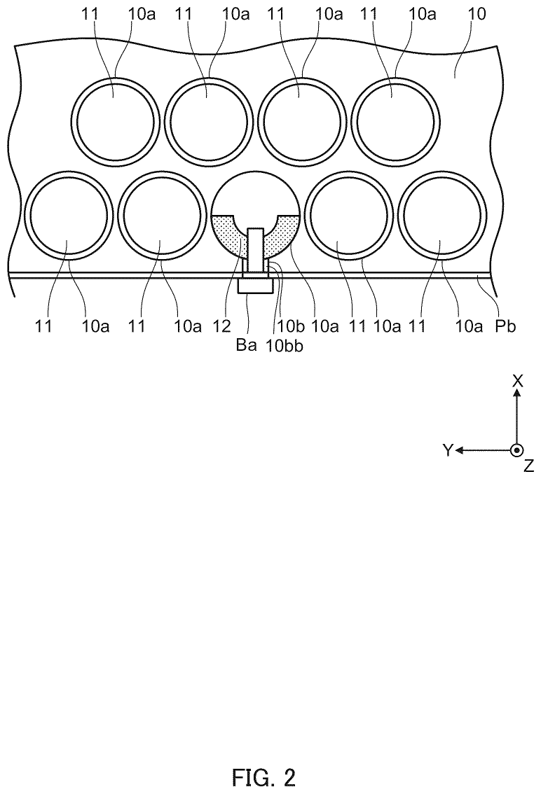

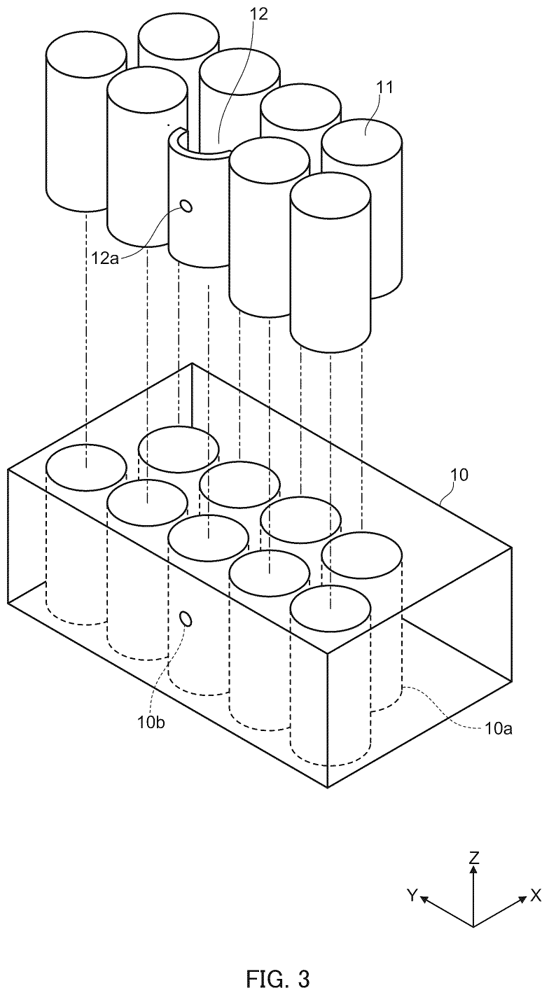

FIG. 1 illustrates a state in which battery module 1 is stored in battery pack P. FIG. 2 is a plan view illustrating a state in which battery cells 11 are stored in cell housing holes 10a of battery module 1. FIG. 3 illustrates a state in which battery cells 11 are stored in cell housing holes 10a of battery module 1 as viewed obliquely from above.

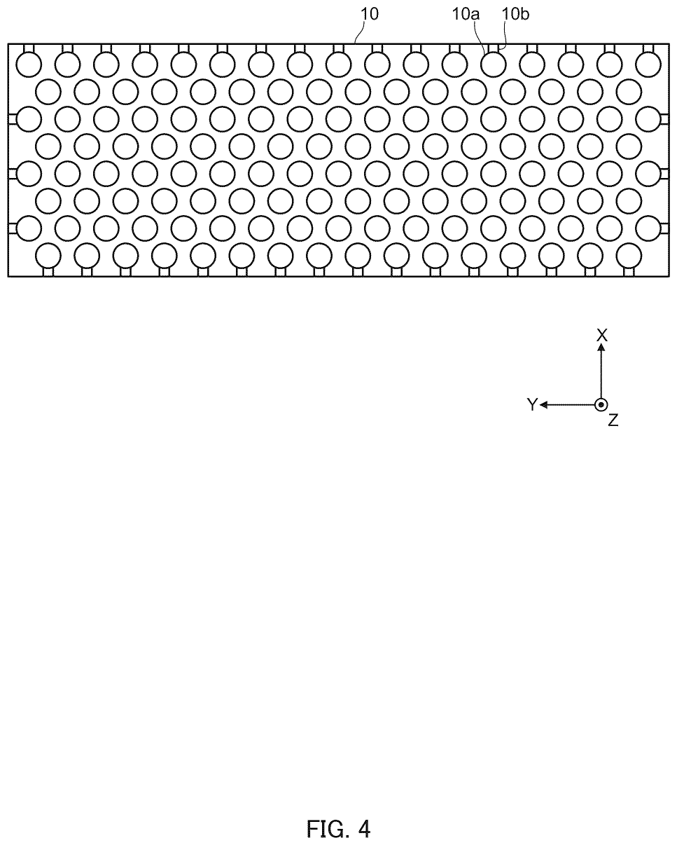

FIG. 4 is a plan view illustrating a configuration of cell housing holes 10a and through holes 10b formed in main body housing 10 of battery module 1. In FIG. 4, drawing of the configuration other than cell housing holes 10a and through holes 10b is omitted.

Battery pack P includes, for example, a rectangular parallelepiped box-shaped main body case Pa, and a plurality of battery modules 1 are stored in main body case Pa. Each battery module 1 is fastened and fixed to main body case Pa of battery pack P by bolt Ba through bracket Pb. The plurality of battery modules 1 are electrically connected to each other by an lead-out electrode (not illustrated) or the like.

A plurality of battery modules 1 stored in battery pack P has, for example, substantially the same configuration. In the following, the configuration of only one battery module 1 will be described. For convenience of explanation, FIG. 1 illustrates only one battery module 1.

Battery module 1 is configured to include main body housing 10, a plurality of battery cells 11, screw receiving member 12, and bus bar 13.

Battery cell 11 is, for example, a cylindrical battery cell. Battery cell 11 includes, for example in a cylindrical case, a positive electrode, a negative electrode, and a separator each having a sheet shape, and an electrolyte solution. Battery cell 11 has, for example, a structure in which the positive electrode and the negative electrode face each other with the separator therebetween and the electrolyte solution is disposed therein.

Battery cell 11 includes, for example, a positive electrode terminal on the upper surface (surface in the positive Z direction), and includes a negative electrode terminal on the lower surface (surface in the negative Z direction). The positive electrode terminal is connected to the positive electrode inside battery cell 11, and the negative electrode terminal is connected to the negative electrode inside battery cell 11.

Battery cell 11 is, for example, a lithium ion battery. However, battery cell 11 may be any one of other types of secondary batteries, such as nickel-cadmium batteries, nickel-metal hydride batteries, and nickel-zinc batteries.

The plurality of battery cells 11 mounted on battery module 1 typically have a similar configuration. The respective battery cells 11 are individually stored in cell housing holes 10a of main body housing 10, in an upright condition. In other words, each battery cell 11 is stored in corresponding cell housing hole 10a of main body housing 10 with the positive electrode terminal and the negative electrode terminal facing in the +Z direction. The positive electrode terminal of each battery cell 11 is, for example, connected to bus bar 13 for the positive electrode. The negative electrode terminal of each battery cell 11 is, for example, connected to bus bar 13 for the negative electrode.

Main body housing 10 is a holder for supporting the plurality of battery cells 11. Main body housing 10 is formed, for example, from an insulating resin material (for example, ABS resin or PBT resin). Main body housing 10 has, for example, a rectangular parallelepiped block shape.

Main body housing 10 includes a plurality of cell housing holes 10a for housing the plurality of battery cells 11 respectively. Each cell housing hole 10a has substantially the same shape as the outer shape of battery cell 11 and has, for example, a cylindrical shape. That is, the plurality of cell housing holes 10a have substantially the same shape. The plurality of cell housing holes 10a are each formed along the +Z directions so as to extend between the upper surface and lower surface of main body housing 10. In other words, the plurality of cell housing holes 10a are disposed such that the circular openings of the cell housing holes are aligned inside main body housing 10 in a plan view.

On the upper surface of main body housing 10, bus bar 13 for the positive electrode is disposed so as to cover cell housing holes 10a, and upper surface cover 10c is disposed on the upper portion of the bus bar. In addition, on the lower surface of main body housing 10, bus bar 13 for the negative electrode is disposed so as to cover cell housing holes 10a, and a lower surface cover (not illustrated) is disposed on the lower portion of the bus bar.

Bus bar 13 for the positive electrode, for example, electrically connects the positive electrode terminals of battery cells 11. Bus bar 13 for the positive electrode is disposed, for example, so as to cover the upper portions of cell housing holes 10a of main body housing 10. In addition, bus bar 13 for the negative electrode, for example, electrically connects the negative electrode terminals of battery cells 11. Bus bar 13 for the negative electrode is disposed, for example, so as to cover the lower portions of cell housing holes 10a of main body housing 10. In the drawing, illustration of bus bar 13 for the negative electrode is omitted.

Bus bar 13 for the positive electrode is connected to the lead-out electrode for the positive electrode (not illustrated), and is electrically connected to bus bar 13 for the positive electrode of another battery module 1 via the lead-out electrode. In addition, bus bar 13 for the negative electrode is connected to a lead-out electrode for the negative electrode (not illustrated), and is electrically connected to bus bar 13 for the negative electrode of another battery module 1 via the lead-out electrode.

Through hole 10b is formed in the side wall of main body housing 10 so as to communicate with one of cell housing holes 10a. In the present embodiment, a large number of through holes 10b are formed in the side wall of main body housing 10, so that a position for fastening main body housing 10 with main body case Pa of battery pack P (i.e., a position for fastening with bracket Pb) can be freely set using bolt Ba. Specifically, in the present embodiment, a plurality of through holes 10b are formed in each of the side wall on the positive X side, the side wall on the negative X side, the side wall on the positive Y side, and the side wall on the negative Y side in main body housing 10 (see FIG. 4). Each of the plurality of through holes 10b is formed so as to communicate with one of the plurality of cell housing holes 10a.

Bolt(s) Ba is inserted into, for example, about one to eight through holes among the plurality of through holes 10b formed in the side wall of main body housing 10. In other words, the hole group structure of such through holes 10b formed in main body housing 10 is intended to enable the fastening position of bolt Ba to be set at any position in main body housing 10. That is, the hole group structure is a configuration that enables a common battery module 1 to be applied regardless of the type of battery pack P.

The position where main body housing 10 and main body case Pa of battery pack P are fastened (i.e., a position where main body housing 10 and bracket Pb are fastened), is the position where screw receiving member 12 is disposed among the plurality of cell housing holes 10a formed in main body housing 10.

Screw receiving member 12 is disposed in cell housing hole 10a—one of the plurality of cell housing holes 10a—that is formed at a position where main body housing and bracket Pb are fastened together. Screw receiving member 12 has a shape that conforms to the inner surface shape of cell housing hole 10a. FIGS. 2 and 3 illustrate a substantially circular arc shape in plan view as an example of the shape of screw receiving member 12. Screw receiving member 12 is formed of, for example, steel for satisfactory strength.

Screw receiving member 12 includes screw hole 12a for the fastening with bolt Ba and is fastened with bolt Ba inserted from the outside of the side wall of main body housing through the through hole 10b. That is, screw hole 12a of screw receiving member 12 is formed at a position where the screw hole communicates with through hole 10b formed in the side wall of main body housing 10.

Here, cell housing hole 10a where screw receiving member 12 is disposed is used for fastening and fixing, and battery cell 11 is not disposed in this cell housing hole 10a. That is, the plurality of cell housing holes 10a formed in main body housing 10 are all formed to house battery cells 11, but at least one of the plurality of cell housing holes 10a is used for fastening and fixing. Therefore, screw receiving member 12 is disposed in place of battery cell 11 in cell housing hole 10a (among the plurality of cell housing holes 10a) used for fastening and fixing. Battery cells 11 are disposed only in the remaining cell housing holes 10a among the plurality of cell housing holes 10a. In other words, bolt Ba is selectively inserted only into a through hole 10b selected as a fastening and fixing position among the plurality of through holes 10b.

In battery module 1 illustrated in FIG. 1, portions for fastening and fixing with bolt Ba (herein each also referred to as “fastening and fixing portion) are set at four locations on the side surface on the positive X side and four locations on the side surface on the negative X side. That is, in battery module 1 illustrated in FIG. 1, screw receiving members 12 are disposed in the eight cell housing holes 10a corresponding to the fastening and fixing portions, and battery cells 11 are disposed in the remaining cell housing holes 10a.

The number and positions of cell housing holes 10a used for fastening and fixing among the plurality of cell housing holes 10a formed in main body housing 10 are different for each type of battery pack P. This is because, as described above, the fixing position of battery module 1 to battery pack P and the number of fixing screws are designed for each type of battery pack P.

Bolt Ba (corresponding to the “screw member” of the present invention) is disposed so as to pass through a through hole 10b, formed in the side wall of main body housing 10, via bracket Pb fixed to battery pack P. Main body housing 10 is fixed to battery pack P by fastening bolt Ba to screw hole 12a formed in screw receiving member 12. Bracket Pb is, for example, L-shaped bracket having an L-shaped cross section, and first mounting surface Pb1 is attached to the side surface of main body housing 10 with bolt Ba, second mounting surface Pb2 is attached to the bottom surface of main body case Pa of battery pack P with bolt Bb.

In through hole 10b formed in the side wall of main body housing 10, an annular spacer 10bb for reinforcing is fitted. Spacer 10bb is formed, for example, from a steel material, and prevents main body housing 10 made of resin from being distorted by the stress acting on main body housing 10 from the seating surface of bolt Ba when bolt Ba is fastened to screw receiving member 12.

### <Fixing Operation of Battery Module 1 to Battery Pack P>

Next, an operation for fixing battery module 1 to battery pack P will be described. The fixing operation, for example, is performed manually by an operator.

First, the operator prepares main body housing 10 of battery module 1, in which cell housing holes 10a and through holes 10b are formed in advance. The operator then disposes negative electrode bus bar 13 and the lower surface cover on the lower surface side of main body housing 10 so as to cover cell housing holes 10a, thereby supporting battery cells 11 within cell housing holes 10a.

The operator then recognizes the position of the fastening and fixing portion among the plurality of cell housing holes 10a formed in main body housing 10, disposes screw receiving member 12 in cell housing hole 10a for fastening and fixing among the plurality of cell housing holes 10a, and disposes battery cells 11 in the other cell housing holes 10a among the plurality of cell housing holes 10a. Then, the operator disposes bus bar 13 for a positive electrode and upper surface cover 10c on the upper surface side of main body housing 10 so as to cover cell housing holes 10a.

The operator then attaches bracket Pb for fixing to the side surface of main body housing 10. At this time, the operator presses first mounting surface Pb1 of bracket Pb against the side wall of main body housing 10, and inserts bolt Ba from the outside of main body housing 10 into bolt insertion hole formed in first mounting surface Pb1 of bracket Pb, causing the bolt to pass through the through hole 10b formed in the side wall of main body housing 10. The operator then inserts bolt Ba to the position of screw hole 12a of screw receiving member 12 in cell housing hole 10a. The operator then fastens bolt Ba with screw hole 12a of screw receiving member 12 using a power tool or the like.

Next, the operator places battery module 1 in main body case Pa of battery pack P. The operator then attaches second mounting surface Pb2 of bracket Pb to the bottom surface of battery pack P by bolt Bb. Specifically, the operator inserts bolt Bb into the bolt insertion hole formed in second mounting surface Pb2 of bracket Pb. The operator then fastens bolt Bb with the screw hole formed in the bottom surface of main body case Pa using a power tool or the like.

By the above-described process, the operation of fixing battery module 1 to battery pack P is performed.

### Effects

As described above, in the structure for fixing battery module 1 to battery pack P according to the present embodiment,
main body housing 10 of battery module 1 includes a plurality of cell housing holes 10a each for housing battery cell 11,
in at least one cell housing hole 10a of the plurality of cell housing holes 10a, battery cell 11 is not disposed, and screw receiving member 12 is disposed in place of battery cell 11, and
screw member Ba is disposed so as to pass through a through hole 10b formed in a side wall of main body housing 10 via bracket Pb fixed to battery pack P, and main body housing 10 is fixed to battery pack P by fastening screw member Ba to screw hole 12a of screw receiving member 12.

That is, the structure for fixing battery module 1 to the battery pack according to the present embodiment employs the following configuration: the fastening structure is incorporated into cell housing hole 10a inside main body housing 10 (that is, screw receiving member 12 is disposed in at least one cell housing hole 10a) without disposing a fastening structure on the outer wall side of main body housing 10.

This allows main body housing 10 itself to be configured with a minimum thickness required to support battery cells 11. In other words, this makes it possible to achieve reduction of the size of battery module 1 as a whole.

In addition, according to the structure for fixing battery module 1 to battery pack P according to the present embodiment, a fastening structure for battery pack P can be configured without performing any special processing on main body housing 10 itself. This makes it possible to use a common battery module 1 for battery packs P with various layouts. In other words, this makes it possible to reduce mold costs by standardizing specifications.

### <Variation>

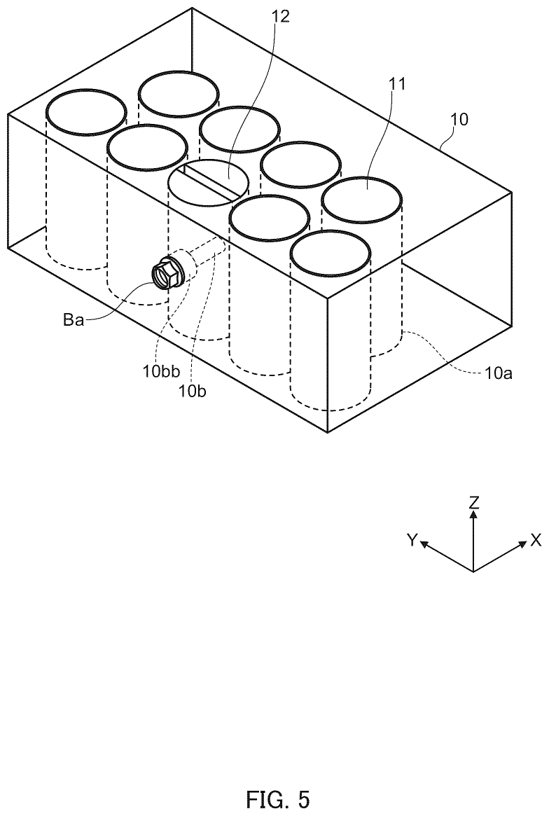

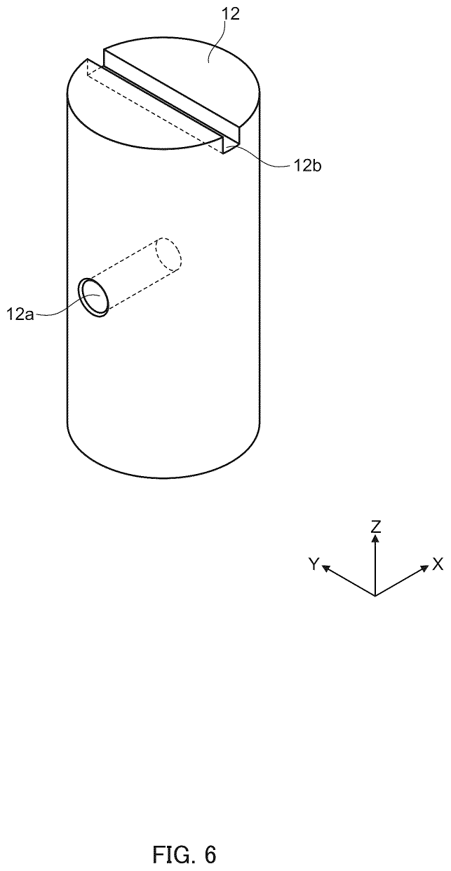

FIG. 5 illustrates a configuration of a variation of the structure for fixing battery module 1 to battery pack P. FIG. 5 is a plan view illustrating a state in which battery cells 11 are stored in cell housing holes 10a of battery module 1. FIG. 6 illustrates a configuration of screw receiving member 12 according to the variation.

The structure for fixing battery module 1 to battery pack P according to the present variation is different from the fixing structure according to the above-described embodiment in that screw receiving member 12 is configured with a block member having substantially the same outer shape as battery cell 11.

Specifically, screw receiving member 12 according to the present variation has a cylindrical shape that conforms to the hole shape of cell housing hole 10a. In addition, on the upper surface of screw receiving member 12 according to the present variation, slit 12b is formed.

Regarding the fixing structure according to the above embodiment, during the bolt fastening operation, the operator needs to support screw receiving member 12 and align the screw receiving member in height and orientation within cell housing hole 10a so that screw hole 12a of screw receiving member 12 communicates with through hole 10b. Then, bolt Ba is needed to be inserted into through hole 10b while screw receiving member 12 is held in the aligned appropriate position in cell housing hole 10a.

In this regard, by configuring screw receiving member 12 with the block member having substantially the same outer shape as battery cell 11, screw receiving member 12 is supported on the lower surface cover within cell housing hole 10a, in the same manner as battery cell 11. In other words, during the bolt fastening operation, the operator only needs to adjust the orientation of screw receiving member 12 so that screw hole 12a of screw receiving member 12 communicates with through hole 10b, and at this time, the operator does not need to support screw receiving member 12.

At this time, adjusting the orientation of screw receiving member 12 can be performed by using slit 12b formed in the upper surface of screw receiving member 12. That is, the operator can easily rotate screw receiving member 12 within cell housing hole 10a, for example, by using a tool such as a screwdriver by fitting the tool into slit 12b.

In such a manner, the structure for fixing battery module 1 to battery pack P according to the present variation can improve workability of the bolt fastening operation.

However, from the viewpoint of weight reduction, the plate member described in the above embodiment is preferred as screw receiving member 12. Therefore, it is preferable to select whether to adopt the block member of according to the present variation or the plate member described in the above embodiment as screw receiving member 12, taking into consideration the usage mode of battery pack P and the like.

FIGS. 5 and 6 illustrate a mode in which the orientation of screw receiving member 12 can be adjusted by using slit 12b formed in the upper surface of screw receiving member 12, but in place of slit 12b, a protrusion may be formed on the upper surface of screw receiving member 12.

In addition, FIGS. 5 and 6 illustrate a mode in which screw receiving member 12 is in a cylindrical shape, but screw receiving member 12 may have a cylindrical shape with a hollow central portion.

### Other Embodiments

The present invention is not limited to the above embodiment and can be applied to various modified modes.

For example, the above embodiment describes, as an example of the configuration of battery cell 11, a cylindrical battery cell in which a positive electrode terminal is disposed on the upper portion side of battery cell 11 and a negative electrode terminal is disposed on the lower portion side of battery cell 11. However, battery cell 11 to be applied to the present invention may be a cylindrical battery cell in which both the positive electrode terminal and the negative electrode terminal formed on the upper portion side.

In addition, the above embodiment describes, as an example of screw hole 12a formed in screw receiving member 12, a screw hole structure formed in screw receiving member 12 itself. However, screw hole 12a may be formed by a welded nut or the like fixed to screw receiving member 12.

The specific examples of the present invention have been described in detail above, but these specific examples are mere examples and do not limit the scope of the claims. The technology described in the claims includes various modifications and variations made in accordance with the specific examples described above.

This application is entitled to and claims the benefit of Japanese Patent Application No. 2024-94370, filed Jun. 11, 2024, the disclosure of which is incorporated herein by reference.

### INDUSTRIAL APPLICABILITY

The structure for fixing a battery module to a battery pack according to the present invention is more preferable in terms of reduction of the size of the battery module and a variation design of the battery pack.

### REFERENCE SIGNS LIST

1 Battery module
10 Main body housing
10a Cell housing hole
10b Through hole
10bb Spacer
10c Upper surface cover
11 Battery cell
12 Screw receiving member
12a Screw hole
12b Slit
13 Bus bar
Ba, Bb Bolt
P Battery Pack
Pa Main body case
Pb Bracket

1. A structure for fixing a battery module to a battery pack, wherein:
a main body housing of the battery module includes a plurality of cell housing holes each for housing a battery cell;
in at least one cell housing hole of the plurality of cell housing holes, the battery cell is not disposed, and a screw receiving member is disposed in place of the battery cell; and
a screw member is disposed so as to pass through a through hole via a bracket and fastened to a screw hole of the screw receiving member, thereby fixing the main body housing to the battery pack, the bracket being fixed to the battery pack, the through hole being formed in a side wall of the main body housing.

2. The structure according to claim 1, wherein:
the battery cell has a cylindrical shape; and
the plurality of cell housing holes each have a cylindrical shape that conforms to an outer shape of the battery cell.

3. The structure according to claim 2, wherein
the screw receiving member has a shape that conforms to an inner peripheral surface of the at least one cell housing hole.

4. The structure according to claim 3, wherein
the screw receiving member has a cylindrical shape.

5. The structure according to claim 4, wherein
a slit or a protrusion is formed on an upper surface of the screw receiving member.

6. The structure according to claim 1, wherein:
a plurality of the through holes are formed in the side wall of the main body housing, each of the plurality of through holes individually communicating with one of the plurality of cell housing holes; and
the screw member is selectively inserted only into a through hole among the plurality of through holes, the through hole being selected as a fastening and fixing position.

7. A method for fixing a battery module to a battery pack, the method comprising:
preparing a main body housing of the battery module, the main body housing including a plurality of cell housing holes each for housing a battery cell;
placing the battery module in the battery pack with the battery cell not disposed and a screw receiving member disposed in place of the battery cell in at least one cell housing hole among the plurality of cell housing holes; and
disposing a screw member so as to pass through a through hole via a bracket that is for fixing to the battery pack, and fastening the screw member to a screw hole of the screw receiving member, the through hole being formed in a side wall of the main body housing.
